(19) United States
(12) Patent Application Publication
(10) Pub. No.: US 2019/0366606 A1
(43) Pub. Date: Dec. 5, 2019

(54) METHOD AND DEVICE FOR PRODUCING INJECTION-MOLDED PARTS

(71) Applicant: ZAHORANSKY Automation & Molds GmbH, Freiburg (DE)

(72) Inventor: Michael Schmidt, Teningen (DE)

(73) Assignee: ZAHORANSKY Automation & Molds GmbH, Freiburg (DE)

(21) Appl. No.: 16/420,614

(22) Filed: May 23, 2019

(30) Foreign Application Priority Data
May 29, 2018 (DE) 102018112858.4

(51) Int. Cl. B29C 45/16; B29C 45/00; B29C 45/04; B29C 45/14

(52) U.S. Cl. CPC B29C 45/1671; B29C 45/0053; B29C 45/1635; B29L 2031/425; B29C 45/14; B29C 45/1618; B29C 45/162; B29C 45/04

(57) ABSTRACT

A device (6) for producing injection-molded parts (1) is provided, with the device device (6) having at least one cooling device (9) in which pre-molded parts (4) are cooled before the injection-molding of a further material component (3). A method is also provided with improvements in the technical field of the production of injection-molded parts (1), in particular of brushes or toothbrush bodies.

### INCORPORATION BY REFERENCE

The following documents are incorporated herein by reference as if fully set forth: German Patent Application No. 10 2018 112 858.4, filed May 29, 2018.

### BACKGROUND

The invention relates to a method for producing injection-molded parts, for example brush or toothbrush bodies, wherein a pre-molded part from at least one first material component is injection-molded in a first injection mold, whereupon at least one further material component is injection-molded to or around the pre-molded part in at least one further or second injection mold.

The invention furthermore also relates to a device for producing injection-molded parts, in particular brush and/or toothbrush bodies, having at least one first injection mold for injection-molding a pre-molded part from at least one first material component and having at least one second injection mold for injection-molding a further or second material component to or around the pre-molded part.

Methods and devices of this type in the most varying embodiments have previously been known in practice. In order for injection-molded parts from more than one material component to be produced in a device of the type mentioned at the outset, a first material component, for example a first color, is usually injection-molded in an injection mold. The injection mold is subsequently opened, the pre-molded part produced from the first material component is retrieved from the first injection mold and fed to a further injection mold. The further material component, for example in another color, is then injected into said further injection mold and is connected to the pre-molded part so as to complement the pre-molded part or so as to complete the injection-molded part.

In the case of the methods known to date, the cooling times of the first material component and of the subsequently injected second or further material component have to be approximately identical so as to keep the cycle times, or production rates, of the individual successive injection-molding steps at approximately equal lengths. In order for the cooling times to be able to be of approximately equal length, the injection-molding volumes of the first and of the further or second material component of an injection-molded part should be approximately identical. In particular when the at least two material components are dissimilarly expensive, it is desirable for the injection volume of the more expensive of the two material components to be chosen so as to be as small as possible, and for costs to be saved in this way. However, by virtue of the dissimilar cooling times of the different material components that are associated with the dissimilar volumes, this leads to deviating cycle times when carrying out the individual injection-molding steps, this ultimately indeed saving material costs but potentially compromising the productivity in the production of injection-molded parts to a significant extent.

### SUMMARY

It is therefore an object of the invention to provide a method and a device of the type mentioned at the outset which avoid the disadvantages outlined above of the previously known methods and devices and permit a more efficient production of injection-molded parts.

In order for said object to be achieved, a method of the type mentioned at the outset for producing injection-molded parts is initially provided, said method having one or more features of the invention directed toward a method of this type. In order for the object to be achieved, it is thus provided in particular in the case of the method mentioned at the outset, that the pre-molded part after the injection-molding of the first material component is retrieved from the first injection mold and is cooled outside the injection molds before the at least one further material component is injection-molded to or around the pre-molded part.

It goes without saying that the method is also suitable for the simultaneous production and processing of a plurality of injection-molded parts or pre-molded parts, respectively.

By the method according to the invention it is possible for the pre-molded part from at least one first material component to be injected, for the pre-molded part to be allowed to cool in the first injection mold only until the external regions thereof have solidified, and then for the remaining cooling time in which the pre-molded part cools until the at least one further material component can be injection-molded to be allowed to elapse outside the injection mold. The at least two material components of which the finished injection-molded part is later composed can thus be injection-molded at dissimilar volumetric ratios without substantially reducing the productivity of the method. It is thus possible for the more expensive of the at least two material components to be injected at a significantly lower volume and for costs to be saved on account thereof. By virtue of the dissimilar volumes or shot weights of the at least two material components of the injection-molded part, the cooling times which have to be adhered to before the pre-molded part, or the completed injection-molded parts, respectively, can be further processed, do indeed differ from one another here too. However, since a majority of the cooling time of the pre-molded part can now proceed outside the injection molds, it is possible for the injection molds for the duration of the cooling time of an already injection-molded pre-molded part to also be used for the injection-molding of further pre-molded parts. The cycle time for the injection-molding of the pre-molded parts in the first injection mold, and the cycle time for the injection-molding of the at least one further material component in the at least one further injection mold, can thus be adjusted to one another, and the method can be operated at at least approximately synchronous cycles.

The pre-molded part can be retrieved from the first injection mold and for cooling be fed to a cooling device. This cooling device can be a so-called external cooling device which is disposed outside the injection molds. In this way, the injection molds can be utilized for the injection-molding of further injection-molded parts/pre-molded parts already after only superficial cooling and curing of the pre-molded parts/injection-molded parts and after the retrieval of the pre-molded parts/injection-molded parts. On account thereof, the method for producing injection-molded parts can be performed with higher productivity as is possible in the case of the methods and devices known to date.

In the case of one embodiment of the method the pre-molded part retrieved from the first injection mold can be actively cooled. To this end, it is particularly expedient for the pre-molded part to be fed to a corresponding cooling device. The pre-molded part in said cooling device can then be cooled to a predefined temperature before the injection-molding of the at least one further material component.

However, it is also possible for the pre-molded part to be passively cooled. In the case of passive cooling of the pre-molded part, the latter can dwell at room temperature for a specific duration, for example on a surface of a cooling device, until said pre-molded part in terms of the temperature thereof has been reduced to the extent that further processing, thus further injection-molding to or around said pre-molded part with a further material component, is possible.

Both the active cooling as well as the passive cooling of the pre-molded part can take place in the cooling device already mentioned above. It is particularly advantageous when the at least one further material component is injection-molded to or around the cooled pre-molded part. To this end, the pre-molded part can be cooled to a temperature which lies below an ambient temperature at which the method is carried out.

In the production of injection-molded parts which are produced from more than two dissimilar material components in more than two different injection-molding steps, it can be expedient for the pre-molded part or the pre-molded parts to be cooled before each further injection-molding step, thus before the injection-molding of each further material component. The pre-molded part herein, for cooling, can be in each case fed to a cooling device assigned to the respective injection-molding step, or always to the same cooling device, for example to the cooling device already mentioned above.

As has already been indicated above, it can be expedient for the cooling device to be disposed outside the injection molds and for the pre-molded part to be retrieved from the cooling device and for injection-molding the at least one further material component to be incorporated in the injection mold provided therefor.

In particular in the case of large volumetric differences between the first material component and a further or second material component, it can be expedient for the pre-molded part to be cooled, in particular in or on the cooling device already mentioned above, at least for the duration of one or else a plurality of injection-molding cycles. The fact that pre-molded parts of a particularly large volume have to be cooled over a comparatively long time until said pre-molded parts have reached the desired temperature or the desired degree of curing in order to be able to be fed to a further injection-molding step for the injection-molding of a further material component, can thus be taken into account.

In the case of one embodiment of the method, polypropylene (PP) and/or polyethylene terephthalate (PET) can be used as the first material component. Thermoplastic elastomer (TPE) can be used as the further or second material component. The at least one first material component can be injection-molded at a volumetric ratio of at least 1.5 to 1; 2 to 1; 5 to 1, or 10 to 1, in relation to the at least one further material component. The larger the mutual volumetric ratio of the at least two material components, the longer it may be necessary for the pre-molded part to be cooled after the injection-molding of the first material component in order for said pre-molded part to reach a temperature which permits the injection-molding of the further material component to or around the pre-molded part.

In order to be able to actively cool the pre-molded part, an active cooling device can be used as the cooling device. Such an active cooling device can, for example, have a cooling apparatus by way of which the cooling device can provide a cooling temperature which lies below the temperature of an environment in which the method is carried out and in which the cooling device is disposed. In the case of another embodiment of the method, a passively cooled cooling device can also be used as the cooling device. A passively cooled cooling device can be, for example, a cooling section or a cooling face. A passively cooled cooling device for pre-molded parts can have, for example, a bearing area from a material which has a comparatively high thermal conductivity and thus facilitates the dissipation of heat from the pre-molded part to the passively cooled cooling device. In principle however, it is also possible for the pre-molded part to be temporarily stored at the ambient temperature outside the injection molds and to be allowed to cool at the ambient temperature for a defined period.

In order for the configuration of a sprue on the pre-molded part, or the injection-molded part, respectively, and thus associated post-processing steps to be avoided, the method can be carried out as a hot runner method while using a hot runner system.

The object is also achieved by a device of the type mentioned at the outset for producing injection-molded parts, said device having one or more features of the invention directed toward such a device. In the case of the device mentioned at the outset for producing injection-molded parts, it is thus proposed that the device has at least one cooling device for pre-molded parts.

In this way, the device is specified for carrying out the method for producing injection-molded parts as has been described in detail above and is claimed in the respective claims. Such a device in its entirety can also be referred to as an injection-molding machine.

The at least one cooling device can preferably be disposed outside the injection molds of the device. It is furthermore possible that the at least one cooling device is an active cooling device or a passive cooling device. An active cooling device can comprise, for example, a cooling apparatus with the aid of which the cooling device can provide a temperature which lies below the temperature of the environment in which the device for producing injection-molded parts is disposed. The cooling of pre-molded parts can be accelerated by way of such an active cooling device. However, it is also possible that the at least one cooling device of the device is a passive cooling device. Such a passive cooling device in the simplest case can be configured as a depositing face onto which pre-molded parts can be deposited so as to dwell thereon at the ambient temperature for a specific duration and to cool to a specific temperature. A passive cooling device, which can also be referred to as a passively cooled cooling device, for pre-molded parts can however also have a depositing face from a material which has a comparatively high thermal conductivity and thus facilitates the dissipation of heat from pre-molded parts deposited on the depositing face and thus cooling of the pre-molded parts.

In order to be able to perform at least part of potentially required manipulation steps of pre-molded parts by way of the at least one cooling device, it can be expedient for the at least one cooling device to have a plurality of, preferably positionally variable, mountings for pre-molded parts. In particular in the case of the so-called hot runner injecting, or hot runner injection-molding, injection points of a first material component and of a second material component at the respective injection molds are attached at dissimilar positions in relation to molding posts or molding cavities of the injection molds. In order for the injection points of the injection molds to be disposed at the same height level in relation to the device, it is necessary for the injection molds and the mold halves thereof to be mutually disposed at a specific offset.

In the case of the injection molds being automatically supplied, a relocation gripper of the device which bridges said height differential, or the offset of the injection mold for the first material component in relation to the injection mold for the second material component, respectively, can be used. When the cooling device has positionally variable mountings for pre-molded parts and is specified for bridging a positional offset between the first injection mold and the at least one further injection mold, the relocation gripper of the device does not have to be specified for bridging this typically vertical offset. To this extent, the relocation gripper can have a lower mass and be displaced at higher speeds and in particular at higher accelerations. On account thereof, the cycle time or the production rate for producing the pre-molded parts and injection-molded parts can be shortened, and the productivity of the device can be increased.

As has already been explained above, the device can have at least one relocation gripper and/or at least one manipulation gripper. With the aid of the relocation gripper at least one pre-molded part can be retrieved from the manipulation gripper and fed to the at least one cooling device. With the aid of the relocation gripper it is also possible for a cooled pre-molded part to be retrieved from the cooling device and to either be fed directly to a further injection mold or else to be transferred to a manipulation gripper of the device, for example to the manipulation gripper already mentioned above. The at least one relocation gripper of the device can thus also be assigned to the at least one cooling device.

The at least one manipulation gripper can serve for retrieving the pre-molded parts from the first injection mold and feeding said pre-molded parts to the at least one cooling device of the device for producing injection-molded parts. With the aid of the same manipulation gripper cooled pre-molded parts can be incorporated into further injection molds of the device so as to therein inject one further material component or a plurality of further material components. It can be particularly advantageous when the manipulation gripper is configured in such a manner that said manipulation gripper is specified for simultaneously inserting pre-molded parts into a further injection mold of the device and for simultaneously retrieving pre-molded parts from the first injection mold, as well as for retrieving completed injection-molded parts from the second or the further injection mold of the device. In this way, all of the injection molds of the device can be served by way of one manipulation gripper. The device can furthermore also have a retrieval device having a retrieval gripper by way of which completed injection-molded parts can at least be indirectly fed to further processing.

A dedicated injection-molding apparatus can be assigned to each injection mold of the device. A material component can be injected into the respective injection mold by way of each of the injection-molding apparatuses. Each injection mold can have a plurality of mold cavities which can also be referred to as molding posts, for producing pre-molded parts or injection-molded parts. In this way, it is possible for a plurality of pre-molded parts or injection-molded parts, respectively, to be produced simultaneously by way of one shot.

Each injection mold of the device can have at least one nozzle-side mold half and at least one ejector-side mold half in which mold halves mutually complementing mold cavities are configured.

In order to avoid the configuration of sprues on the pre-molded parts or injection-molded parts, respectively, said sprues requiring post-processing of the pre-molded parts or injection-molded parts, respectively, the device can furthermore have a hot runner system. The material components can be injected into the at least two injection molds of the device by way of the hot runner system.

The device can furthermore have a number of cooling devices, said number being one less than the number of injection molds. In this way each injection mold which serves for producing or complementing pre-molded parts can in each case have available a cooling device for cooling the pre-molded parts produced.

In the case of one embodiment of the device the at least one cooling device is configured as a cooling tower which has at least two levels or cooling levels which are disposed on top of one another and which have mountings for pre-molded parts. In this way, a cooling device which is particularly compact and moreover offers a large number of individual mountings and thus permits the cooling of pre-molded parts optionally also over the duration of a plurality of injection cycles is made available. The mountings for the pre-molded parts of the at least one cooling device herein can be rotatable about a rotation axis of the cooling device, for example. The cooling device herein can have a drum, the mountings for the pre-molded parts being disposed or configured on the external side of said drum. The cooling device can thus serve as a rotatable magazine for pre-molded parts to be cooled, said magazine being able to be rotated in a cycled manner, for example in the operating cycle in which the injection-molding steps are carried out.

The device can have a cooling apparatus or else a plurality of cooling apparatus for the at least one cooling device. The cooling device can in this way be cooled so as to meet requirements. The at least one cooling device can furthermore comprise a plurality of cooling chambers which are in particular configured or disposed in or on drawers and into which the pre-molded parts can be inserted for cooling.

In summary, the invention thus relates to improvements in the technical field of the production of injection-molded parts, in particular of brush or toothbrush bodies. To this end, the device for producing injection-molded parts which can also be referred to as an injection-molding machine and which has at least one cooling device in which pre-molded parts can be cooled before the injection-molding of a further material component is inter alia provided.

### BRIEF DESCRIPTION OF THE DRAWINGS

The invention will now be described in more detail by using exemplary embodiments but is not limited to these exemplary embodiments. Further exemplary embodiments of the invention are derived by mutually combining the features of individual or a plurality of claims and/or by combining individual or a plurality of features of the exemplary embodiments. In the figures, in part in a highly schematic illustration:

FIG. 1: shows a plan view of an injection-molded part in the form of a toothbrush body, produced according to the method described in detail above;

FIG. 2: shows a sectional view of the toothbrush body along the line identified by II-II in FIG. 1;

FIG. 3: shows the detail marked by A in FIG. 2, in an enlarged illustration;

FIG. 4: shows a first exemplary embodiment of a device for producing injection-molded parts in a highly schematic illustration, wherein a total of two injection-molding apparatuses for injection-molding two dissimilar material components or colors, a cooling device for the external cooling of pre-molded parts, and a retrieval device for retrieving finished injection-molded parts can be seen;

FIG. 5: shows a highly schematic view of a further device according to the invention for producing injection-molded parts, wherein the device has a total of three injection-molding apparatuses for injection-molding three dissimilar material components or colors, two external cooling devices, a manipulation gripper, a relocation gripper, as well as a retrieval device having a retrieval gripper;

FIG. 6: shows a further exemplary embodiment of a device according to the invention for producing injection-molded parts, wherein the device makes use of the concept of the device illustrated in FIG. 5, and has two injection-molding apparatuses as well as a cooling device;

FIG. 7: shows the detail marked by the rectangle B in FIG. 6, in an enlarged illustration;

FIG. 8: shows the detail marked by the rectangle C in FIG. 6, in an enlarged illustration;

FIG. 9: shows the device for producing injection-molded parts illustrated in FIGS. 6 to 8, wherein pre-molded parts, or completed injection-molded parts, respectively, injection-molded by way of the two injection-molding apparatuses have been removed from both injection molds and moved to the respective transfer position with the aid of a manipulation gripper of the device;

FIG. 10: shows the detail marked by the rectangle D in FIG. 9, in an enlarged illustration, wherein the receiving spaces or mountings of the cooling device for pre-molded parts are occupied by pre-molded parts; and

FIG. 11: shows the detail marked by the rectangle E in FIG. 9, in an enlarged illustration, wherein mold cavities of the two injection molds for producing pre-molded parts, on the one hand, and for producing injection-molded parts from the pre-molded parts, on the other hand, can be seen here.

### DETAILED DESCRIPTION

In the description hereunder of different embodiments of the invention, elements which in terms of the function thereof are identical, are provided with identical reference signs, even in the case of a deviating design or shape.

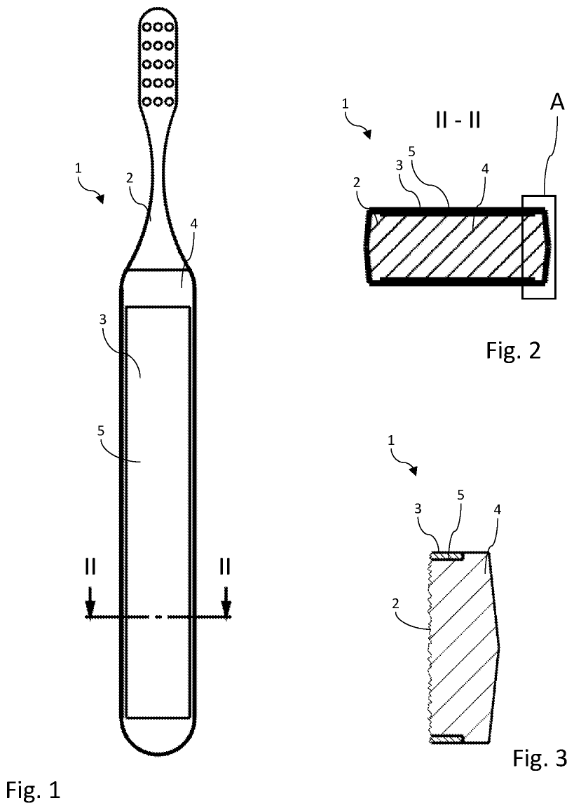

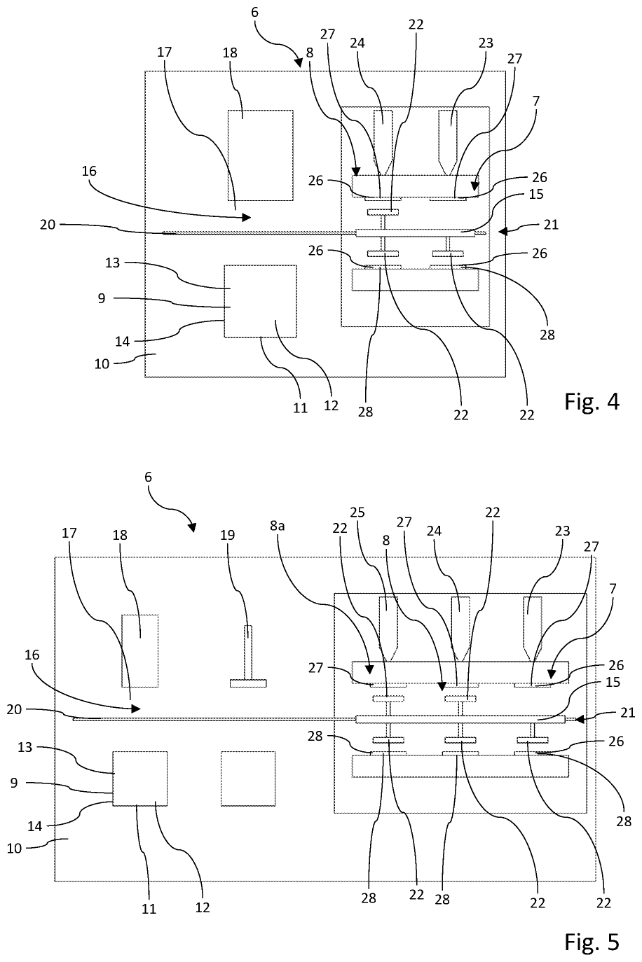

FIGS. 1 to 3 show an injection-molded part which as an entity is identified by the reference sign 1 and which in the present case is configured as a toothbrush body. The injection-molded part 1 illustrated in FIGS. 1 to 3 is injection-molded from two dissimilar material components or colors 2 and 3. The material components 2 and 3 can be particularly readily seen in the sectional illustrations according to FIGS. 2 and 3.

The first material component 2 of the two material components 2 and 3 herein forms a main body 4 of the injection-molded part 1.

The second material component 3 forms an overmolding 5 of the main body 4 of the injection-molded part 1 and is injection-molded in a dedicated injection-molding step. The overmolding 5 of the injection-molded part 1 which is composed of the second material component 3 has a significantly smaller volume than the main body 4 which is injection-molded from the first material component 2 and which also can be referred to as the pre-molded part 4. Since the first material component 2 is injection-molded so as to have a larger volume than the second material component 3, the second material component 3 for the production of the overmolding 5 can be more expensive than the first material component 2.

The dissimilar volumes of the main body 4, on the one hand, and of the overmolding 5 of the main body 4 of the injection-molded part 1, on the other hand, are associated with cooling times of dissimilar length after the injection-molding of the respective material components 2 and 3, the adherence to said cooling times in the case of the methods and the device known to date overall leading to extended cycle times in the injection-molding of the two material components 2 and 3.

In order for the cycle times in the production of injection-molded parts 1 which are injection-molded from at least two material components 2 and 3 at dissimilar volumes to be adjusted and to overall be kept as short as possible, it is proposed for the pre-molded parts 4 to first be cooled externally, that is to say outside the injection-molds 7 and 8, before the second or else a further material component or color 3 is injection-molded. The device 6, explained in detail hereunder, is provided and specified to this end.

All of the devices 6 illustrated in the figures for producing injection-molded parts 1 have at least one first injection mold 7 for injection-molding a pre-molded part 4 from at least one first material component 2 and at least one further or second injection-mold 8. One further material component, specifically the second material component 3 already mentioned above, can be injection-molded to or around the pre-molded part 4 in the second injection mold 8, so as to complement the pre-molded part 4 and to thus complete the injection-molded part 1, for example a toothbrush body.

To this end, the pre-molded part 4 produced in the first injection mold 7 is transferred into the second injection mold 8. The second material component 3 for generating an overmolding 5 of the toothbrush body 4 is then injected in the second injection mold 8, and either an already completed injection-molded part 1 is generated or a further pre-molded part which is still complemented in a further injection-molding step is produced.

Each of the devices 6 illustrated in the figures has in each case one cooling device 9 for pre-molded parts 4. Each cooling device 9 illustrated in the figures herein is disposed on a frame 10 of the device 6 so as to be outside the at least two injection molds 7 and 8.

The cooling devices 9 illustrated in the figures are so-called active or actively cooled cooling devices 9 which are in each case equipped with one cooling apparatus 11. With the aid of the respective cooling apparatus 11, a plurality of pre-molded parts 4 can be simultaneously cooled and thus prepared for at least one subsequent injection-molding step. The illustrations 7 and 10 of cooling devices 9 highlight in particular that said cooling devices 9 have in each case a plurality of mountings 12 for receiving pre-molded parts 4.

The mountings 12 are configured on a rotatable drum 13 of the respective cooling device 9. The mountings 12 and the pre-molded parts 4 disposed thereon are positionally variable by rotating the drum 13 about the rotation axis R thereof and by displacing the drum 13 along linear guides 14 of the cooling devices 9.

Each of the devices 6 illustrated in the figures furthermore has a manipulation gripper 15. With the aid of the respective manipulation gripper 15, pre-molded parts 4 injection-molded in the first injection mold 7 can be retrieved from said first injection mold 7 and first fed to the cooling device 9 which is assigned to the first injection mold 7. By way of a gripper module 22 of the manipulation gripper 15, pre-molded parts 4 that have been cooled in the cooling device 9 can be retrieved from the cooling device 9 and fed to the subsequent second injection mold 8, so as to overmold the cooled pre-molded parts 4 with an overmolding 5 from the second material component 3.

The respective manipulation gripper 15 ultimately also serves for retrieving completed injection-molded parts 1 from the last injection mold 8 of a series of injection molds 7 and 8 and to transport said completed injection-molded parts 1 to a transfer position 16. The completed injection-molded parts 1 in said transfer position 16 can be retrieved by way of the manipulation gripper 15 and, with the aid of a retrieval gripper 17, be deposited on a depositing face 18 of the device 6 and/or be transferred to a downstream processing station.

In the case of the device 6 according to FIG. 5 a relocation gripper 19 is moreover provided. Said relocation gripper 19 serves for retrieving the pre-molded parts 4 of a first material component or color 2 from the manipulation gripper 15 and to feed said pre-molded parts 4 to a first cooling device 9 which is downstream of and assigned to the first injection mold 7. Once the pre-molded parts 4 in the case of this device 6 according to FIG. 5 have been correspondingly cooled in the first cooling device 9, said pre-molded parts 4 can be fed to the downstream further injection mold 8. The pre-molded parts 4 in this downstream injection mold 8 are provided with a first overmolding 5. The overmolded pre-molded parts 4 with the aid of the manipulation gripper 15 subsequently make their way to a further cooling device 9 of the device 6, said cooling device 9 being assigned to the second injection mold 8. Said pre-molded parts 4 at the cooling device 9 are again cooled so as to be subsequently fed in the cooled state to a third downstream injection mold 8a.

The pre-molded parts 4 here are imparted a further overmolding 5 from a third material component, and can then be retrieved as completed injection-molded parts 1 from said last injection mold 8a in the series of three injection molds. Said completed injection-molded parts 1, with the aid of the retrieval gripper 17 of said device 6, are transferred by the manipulation gripper 15 to the depositing face 18, or to a downstream processing station, respectively.

In the case of all exemplary embodiments of the devices 6 which are illustrated in the figures, the manipulation gripper 15 is mounted so as to be displaceable along a guide rail 20 on the frame 10 of the device 6. In this way, the manipulation gripper 15 can be repositioned between the transfer position 16 on the retrieval gripper 17 and an insertion and retrieval position 21 neighboring the at least two injection molds 7 and 8.

The manipulation grippers 15 of each of the devices 6 illustrated in the figures herein are specified for retrieving and inserting pre-molded parts 4, and moreover for retrieving injection-molded parts 1 from the respective injection mold 7 or 8, respectively. To this end, the manipulation grippers 17 have respective gripper modules 22.

With the aid of the manipulation grippers 15 and the respective gripper modules 22, it is furthermore possible for the cooling devices 9 of the respective devices 6 to be supplied with pre-molded parts 4 to be overmolded. According to the figures, each injection mold 7, 8, and 8a is in each case assigned one dedicated injection-molding apparatus 23, 24, or 25, respectively. One of the material components 2 and 3, by way of each injection-molding apparatus 23, 24 and 25, can in each case be injected into the respectively assigned injection mold 7 or 8, respectively, and 8a.

Each injection mold 7, 8, and 8a has in each case one nozzle-side mold half 27 as well as one ejector-side mold half 28 in which mold halves 27, 28 mutually complementing mold cavities 26 are configured. With the aid of the injection-molding apparatuses 23, 24, and 25, the dissimilar material components or colors 2 and 3 can be injected into the mold cavities 26 for initially producing the pre-molded parts 4 and subsequently for producing the injection-molded parts 1. The infeeding of the material components herein can be performed by way of a hot runner system (not specifically illustrated in the figures).

In the case of all of the exemplary embodiments illustrated in the figures of devices 6 for producing injection-molded parts 1 a number of cooling devices 9 is provided, said number being one less than the number of the injection molds 7, 8, and 8a, and also one less than the number of injection-molding apparatuses 23, 24, and 25. In this way, each injection mold 7, 8, and 8a, and thus each injection-molding apparatus 23, 24, and 25, which are/is provided for producing pre-molded parts 4, is in each case assigned one cooling device 9 for cooling the pre-molded parts 4 produced therewith.

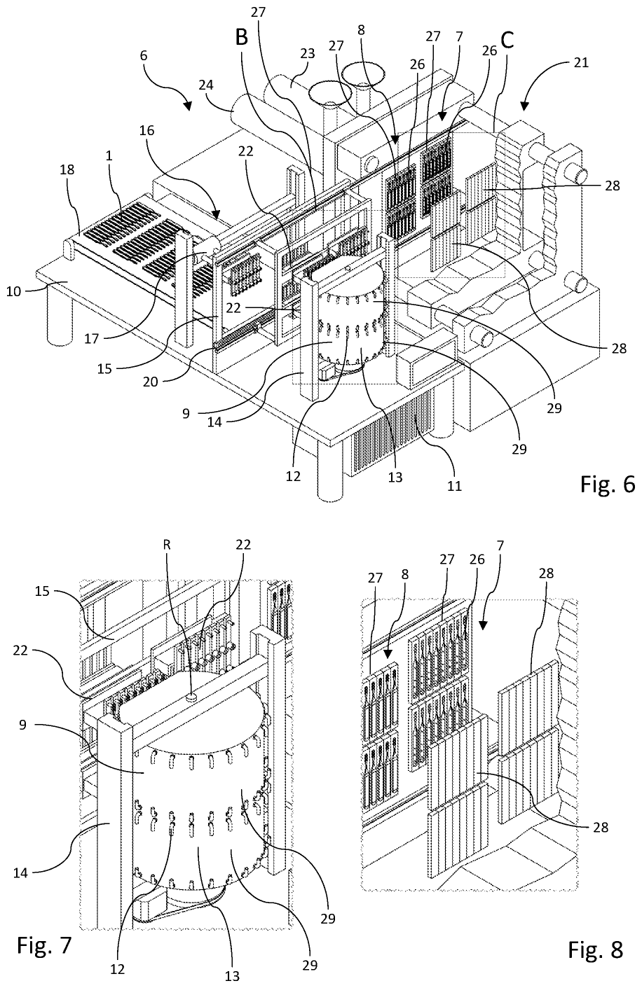

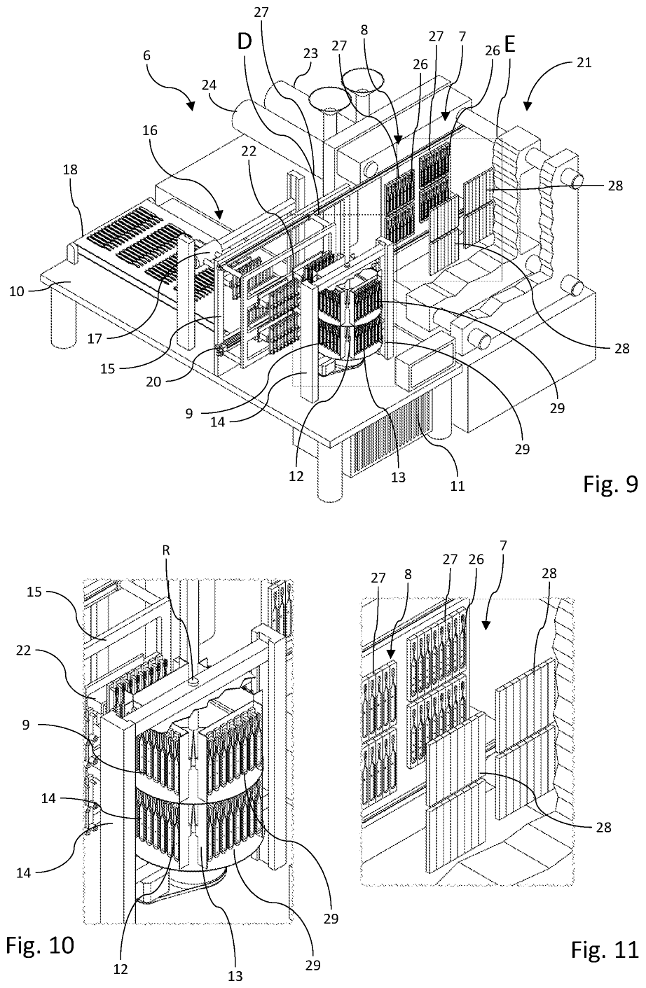

Specifically, the cooling devices 9 of the devices 6 for producing injection-molded parts 1 illustrated in the figures are configured as cooling towers. Each of the cooling devices 9 has in each case two levels 29 having mountings 12 for pre-molded parts 4. As has already been explained above, the cooling devices 9 have rotatable drums 13 which are moreover height-variable along the linear guides 14. In this way, the cooling devices 9 can be vertically adjusted so as to correspond to the pre-molded parts 4 that are held ready for transfer on the manipulation gripper 15. FIGS. 6 and 8, as well as 9 and 11, highlight that the injection molds 7, 8 or 8a, respectively, are mutually disposed at a certain offset in height.

This is caused by the dissimilar injection points by way of which the first material component 2 and the second or third, respectively, material component 3 are injected into the injection molds 7 and 8, as well as optionally 8a. In order for injection nozzles of the injection-molding apparatuses 23, 24, and 25 to be able to be disposed at the same height, it is necessary for the injection molds 7, 8, and 8a to be mutually disposed at a corresponding vertical offset. Said offset which can be seen in FIGS. 6 and 8, as well as 9 and 11, can be equalized either by way of a corresponding kinematic system of the manipulation gripper 15 or else, this being preferable, by way of the height adjustability of the respective cooling device 9, described above. In this way, the manipulation gripper 15 can be designed to be of simpler construction and lighter. This in turn facilitates high acceleration values, on account of which the manipulation gripper 15 can be repositioned more rapidly and the cycle times can overall be shortened.

The method described hereunder for producing injection-molded parts 1 can be carried out on the devices 6 for producing injection-molded parts 1, described in detail above.

It is provided herein that pre-molded parts 4 from at least one first material component 2 are injection-molded in a first injection mold 7, whereupon at least one further material component 3 is injection-molded to or around the previously produced pre-molded parts 4 in at least one further injection mold 8, 8a.

The pre-molded parts 4 are retrieved from the first injection mold 7 and are cooled outside the two or else three injection molds 7, 8, and optionally 8a, before the at least one further material component 3 is injection-molded to or around the pre-molded parts 4 in order for the injection-molded parts 1 to be completed.

The pre-molded parts 4 for cooling are fed to a cooling device 9. The pre-molded parts 4 are actively cooled in the cooling device 9. The at least one further material component 3 is then injection-molded to or around the cooled pre-molded parts 4. Since the pre-molded parts 4 have a larger volume than the overmolding 5 that has been injection-molded to the pre-molded parts 4, said pre-molded parts 4 at room temperature would require a longer time to cool to a temperature required for injection-molding the further material component 3 to or around said pre-molded parts 4. Without the external cooling devices 9, the pre-molded parts 4 would thus have to dwell longer in the first injection mold 7, which overall would lead to a prolongation of the cycle times or production rates when carrying out the injection-molding method for producing the injection-molded parts 1.

When the pre-molded parts 4 in further injection-molding steps are to be provided with further overmoldings 5 from further material components 3, the pre-molded parts 4 are cooled by the cooling devices 9 before the injection-molding of each further material component 3. To this end, the pre-molded parts 4 can in each case be fed to a cooling device 9 that is downstream of and assigned to the respective injection mold 7 or 8, or else only to one cooling device 9 which in this instance is provided for cooling all of the pre-molded parts 4. Said cooling device 9 in this instance is thus assigned to two or a plurality of injection molds 7 and 8 by way of which the pre-molded parts 4 are generated.

Each cooling device 9 is disposed outside the injection molds 7 and 8. In this way, the cooling of the pre-molded parts 4 in temporal terms can be decoupled from the injection-molding of the pre-molded parts 4 and the injection-molded parts 1. After cooling, the pre-molded parts 4 are retrieved from the respective cooling device 9 and for injection molding the at least one further material component 3 is incorporated in the downstream injection mold 7, 8, or 8a provided to this end.

For example, the pre-molded parts 4 can dwell and cool in or on the cooling device 9 for the duration of one injection-molding cycle. In particular when the volumes at which the dissimilar material components 2 and 3 are injection-molded deviate heavily from one another, thus when the volume of the first material component 2 on the injection-molded part 1 is significantly larger than the volume of the second material component 3 which forms the overmolding 5, for example, it can be expedient for the pre-molded part 4 to be cooled for a plurality of injection-molding cycles or operating cycles in or on the cooling device 9 provided to this end.

Polypropylene (PP) and/or polyethylene terephthalate (PET) can be injection-molded as the first material component 2, for example. Thermoplastic elastomer (TPE) can be used as the second, typically more expensive, material component 3 for producing the overmolding 5 of the pre-molded parts 4.

The volumetric ratio at which the first material component 2 is injection-molded in relation to the at least one further material component 3 for producing the injection-molded part 1 can be, for example, at least 1.5 to 1; 2 to 1; 5 to 1, or else at least 10 to 1.

As has already been mentioned above, an actively cooled cooling device 9 which possesses a cooling apparatus 11 is preferably used as the cooling device 9. In principle however, the use of passively cooled cooling devices 9 which, for example by virtue of the material of which said cooling devices 9 are composed, are particularly well suitable for the dissipation of heat, is also conceivable. A simple cooling section or cooling face onto which the pre-molded parts 4 can be deposited for cooling can also be used as the cooling device 9.

### LIST OF REFERENCE SIGNS

1 Injection-molded part

2 First material component

3 Second material component

4 Main body/Pre-molded part

5 Overmolding

6 Device for producing injection-molded parts

7 First injection mold

8 Second injection mold

8a Further/third injection mold

9 Cooling device

10 Frame of 6

11 Cooling apparatus of 9

12 Mounting on 9

13 Drum of 9

14 Linear guide of 9

15 Manipulation gripper

16 Transfer position

17 Retrieval gripper

18 Depositing face

19 Relocation gripper

20 Guide rail

21 Insertion and retrieval position

22 Gripper modules

23 Injection-molding apparatus

24 Injection-molding apparatus

25 Injection-molding apparatus

26 Mold cavity

27 Nozzle-side mold half

28 Ejector-side mold half

29 Levels

R Rotation axis of 13

1. A method for producing injection-molded parts (1), comprising:
injection-molding a pre-molded part (4) from at least one first material component (2) in a first injection mold (7);
retrieving the pre-molded part (4) from the first injection mold (7) and cooling the pre-molded part (4) outside the injection molds (7, 8, 8a) before further injection-molding; and
injection-molding at least one further material component (3) to or around the pre-molded part in at least one further injection mold (8, 8a).

2. The method as claimed in claim 1, further comprising feeding the pre-molded part (4) for cooling to a cooling device (9), actively or passively cooling the pre-molded part (4) in the cooling device (9), and the at least one further material component (3) is injection-molded to or around the cooled pre-molded part (4).

3. The method as claimed in claim 1, wherein the pre-molded part (4) is cooled prior to the injection-molding of each said further material component (3), by being fed in each case to a cooling device (9).

4. The method as claimed in claim 1, wherein the cooling device (9) is disposed outside the injection molds (7, 8, 8a), and the pre-molded part (4) is retrieved from the cooling device (9) and for injection-molding the at least one further material component (3) is incorporated in the injection mold provided therefor.

5. The method as claimed in claim 1, further comprising cooling the pre-molded part (4) at least for the duration of one injection-molding cycle.

6. The method as claimed in claim 1, wherein at least one of polypropylene (PP) or polyethylene terephthalate (PET) are used as the first material component (2), and a thermoplastic elastomer (TPE) is used as the second material component (3).

7. The method as claimed in claim 1, wherein the at least one first material component (2) is injection-molded at a volumetric ratio of at least 1.5 to 1; 2 to 1; 5 to 1, or 10 to 1, in relation to the at least one further material component (3).

8. The method as claimed in claim 1, wherein the method is carried out using a hot runner system

9. The method as claimed in claim 2, wherein the cooling device is an actively cooled cooling device (9).

10. A device for producing injection-molded parts (1), comprising:
at least one first injection mold (7) for injection-molding a pre-molded part (4) from at least one first material component (2);
at least one further injection mold (8) in which a further material component (3) is adapted to be injected to or around the pre-molded part (4); and
at least one cooling device (9) configured to cool the pre-molded parts (4).

11. The device (6) as claimed in claim 10, wherein the at least one cooling device (9) is disposed outside the injection molds (7, 8, 8a), and the at least one cooling device (9) is an active cooling device.

12. The device (6) as claimed in claim 11, wherein the at least one cooling device (9) has a plurality of mountings (12) for the pre-molded parts (4).

13. The device (6) as claimed in claim 10, further comprising at least one of a relocation gripper (19) assigned to the at least one cooling device (9), a manipulation gripper (15) assigned to the at least one cooling device (9), or a retrieval gripper (17).

14. The device as claimed in claim 13, wherein the manipulation gripper (15) is configured for at least one of retrieving or inserting at least one of the pre-molded parts (4) or the molded parts (1) at least one of from or into the first injection mold (7), from or into the at least one further injection mold (8, 8a), or from or into the at least one cooling device (9).

15. The device (6) as claimed in claim 10, wherein each said injection mold has at least one nozzle-side mold half (27) and at least one ejector-side mold half (28) in which mold halves (27, 28) mutually complementary mold cavities (26) are configured.

16. The device (6) as claimed in claim 10, wherein the at least one cooling device comprises a number of cooling devices (9), said number being one less than a number of the injection molds (7, 8, 8a).

17. The device (6) as claimed in claim 10, wherein the at least one cooling device (9) is configured as a cooling tower which has at least two levels (29) which are disposed on top of one another and which have mountings (12) adapted to receive the pre-molded parts (4).

18. The device (6) as claimed in claim 10, wherein the device (6) has at least one cooling apparatus (11) for the at least one cooling device (9), and the at least one cooling device (9) comprises a plurality of cooling chambers which are configured or disposed in or on drawers.

19. The device (6) as claimed in claim 10, wherein the device for is configured for producing at least one of brush or toothbrush bodies.
